(19) United States
(12) Patent Application Publication
(10) Pub. No.: US 2010/0052457 A1
(43) Pub. Date: Mar. 4, 2010

(54) METHODS AND APPARATUS FOR FABRICATION OF ELECTRIC MOTORS

(76) Inventors: Subhash M. Brahmavar, Fort Wayne, IN (US); Thaylen Leany, Fort Wayne, IN (US); Harold C. Kingrey, Huntington, IN (US); Xiaochuan Jia, Centerville, OH (US)

Correspondence Address: Patent Docket Department;Armstrong Teasdale LLP, One Metropolitan Square, Suite 2600, St. Louis, MO, 63102-2740, US

(21) Appl. No.: 12/201,733

(22) Filed: Aug. 29, 2008

(51) Int. Cl. H02K 1/28

(52) U.S. Cl. 310/156.13

(57) ABSTRACT

A rotor assembly for an electric motor is described that includes a rotor shaft, a ferromagnetic core mounted on the rotor shaft, and at least one cylindrical shaped magnet configured to engage and substantially surround the length of the ferromagnetic core. The at least one magnet is fabricated utilizing neodymium.

### BACKGROUND

The field of the disclosure relates generally to electric motors, and more particularly, to methods and apparatus for fabrication of electric motors.

Electric motors, of which electronically commutated motors (ECMs) are but one example, are used in a wide variety of applications. ECMs are sometimes referred to in the industry, and herein, as brushless DC motors. ECMs, like other motors, generally incorporate a magnetic rotor core that is energized by the electric field emanating from a stator assembly. In certain motors, the rotor core is magnetized using ferrite arc magnets, which are sometimes referred to as ferrite arcs. In such motor configurations, it is important to secure the ferrite arcs to the rotor core such that long term reliability of magnet attachment is ensured. The high speed and centrifugal force due to rotor rotation tends to apply forces to the ferrite arcs in a direction that work towards separating the ferrite arcs from rotor core.

In most applications, the ferrite arcs are attached to the rotor core with an adhesive. However, most adhesives deteriorate over time due to exposure to humidity and temperature and the bond between the rotor core the ferrite magnet arcs fails. Various mechanical magnet retention methods have been tested, including plastic over molding, heat shrinkable mylar sleeves, and stainless steel cans or cups. However, each of these retention methods either affect efficiency of the motor product and/or add costs to the motor product.

### BRIEF SUMMARY

In one aspect, a rotor assembly for an electric motor is provided. The rotor assembly includes a rotor shaft, a ferromagnetic core mounted on the rotor shaft, and at least one cylindrical shaped magnet configured to engage and substantially surround the length of the ferromagnetic core. The at least one magnet is fabricated utilizing neodymium.

In another aspect, an electric motor is provided that includes a rotor assembly comprising a rotor shaft, a ferromagnetic core mounted on the rotor shaft, and at least one ring shaped magnet configured to engage and substantially surround the ferromagnetic core. The ring shaped magnets are fabricated from neodymium, and the electric motor further includes a plurality of windings for causing a rotation of the rotor assembly.

In still another aspect, an electric motor is provided that includes a stator assembly and a rotor assembly. The rotor assembly includes a rotor shaft, a ferromagnetic core mounted on the rotor shaft, and at least one ring shaped magnet configured to engage and substantially surround the ferromagnetic core. An output of the motor is configurable based on at least one of a magnetic material utilized in the fabrication of the at least one ring shaped magnet and a magnetization level of the at least one ring shaped magnet.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is an exploded view of an integrated electronically commutated motor (ECM) and control circuit assembly.

FIG. 2 is a fully assembled view of the ECM and control circuit assembly of FIG. 1.

FIG. 3 is an exploded end view of an alternative embodiment for an ECM.

FIG. 4 is a detailed view of a rotor assembly that incorporates a neodymium ring shaped magnet mounted on a ferromagnetic rotor core.

FIG. 4A is a detailed view of a rotor assembly that incorporates a plurality of magnetic rings in an axial orientation along the rotor.

FIG. 4B is a detailed view of a rotor assembly where the magnetic ring overhangs the ferromagnetic core.

FIGS. 5-10 illustrate various configurations that prevent relative rotational movement between a neodymium ring shaped magnet and a ferromagnetic rotor core.

FIG. 11 illustrates an end plate and pin configuration to prevent relative rotational movement between a neodymium ring shaped magnet and a ferromagnetic rotor core.

FIGS. 12-14 illustrate several example embodiments for magnetic ring outer diameter that are shaped to reduce cogging torque.

### DETAILED DESCRIPTION

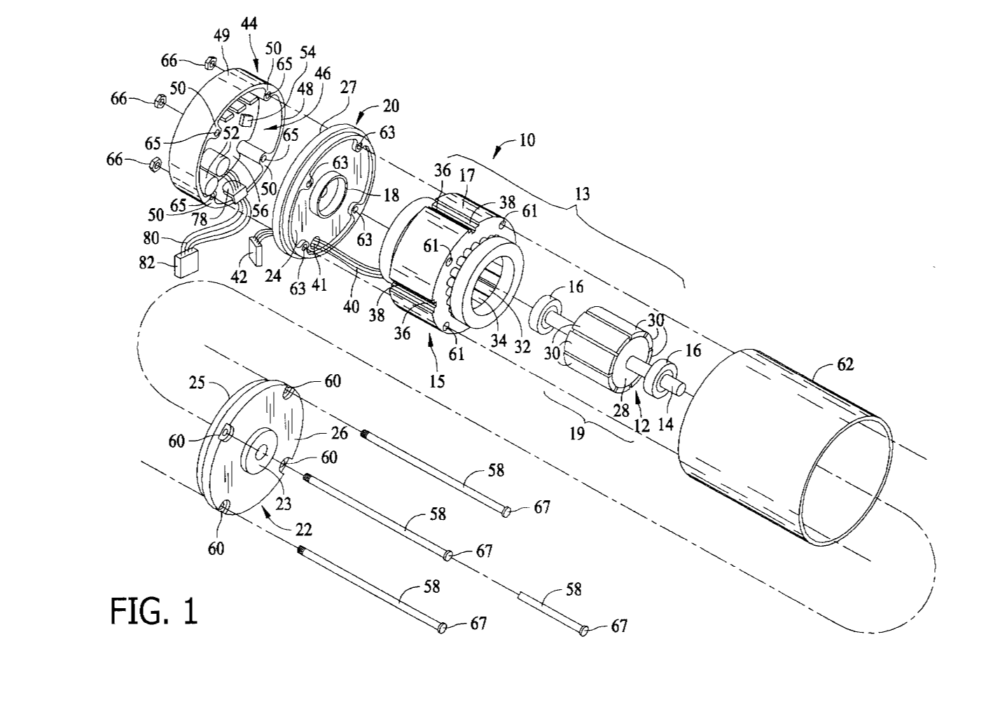

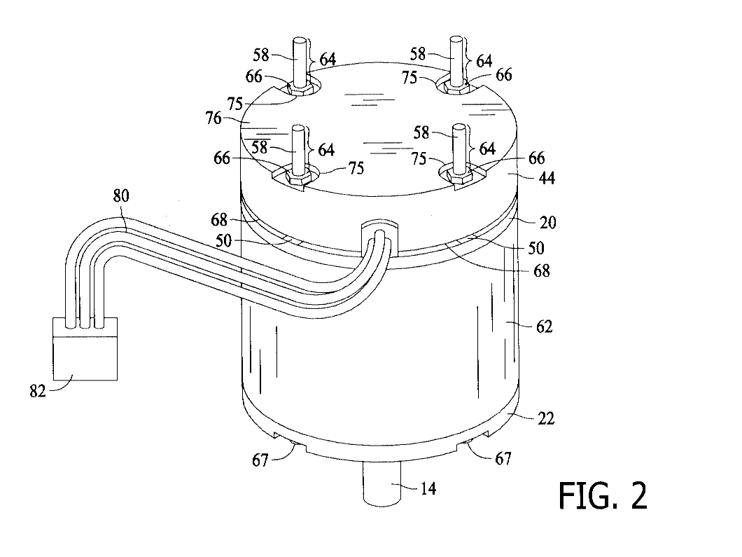

Referring to the drawings, and more particularly to FIGS. 1 and 2, reference character 10 generally designates an integrated electronically commutated motor and control circuit assembly. Motor assembly 10 comprises a brushless electronically commutated DC motor 13 having a stationary assembly 15 including a stator or core 17 and a rotatable assembly 19 including a permanent magnet rotor 12 and a shaft 14. A fan (not shown) or other means to be driven such as means for moving air through an air handling system engages the shaft 14. Specifically, motor assembly 10 is for use in combination with an air handling system such as an air conditioning system including a fan for blowing air over cooling coils for supplying the cooled air to a building.

Rotor 12 is mounted on and keyed to the shaft 14 journaled for rotation in conventional bearings 16. The bearings 16 are mounted in bearing supports 18 integral with a first end member 20 and a second end member 22. The end members 20 and 22 are substantially flat and parallel to each other. The end members 20 and 22 have inner facing sides 24, 25 between which the stationary assembly 15 and the rotatable assembly 19 are located. Each end member 20 and 22 has an outer side 26, 27 opposite its inner side 24, 25. Additionally, second end member 22 has an aperture 23 for the shaft 14 to pass through and extend out from the outer side 26.

The rotor 12 comprises a ferromagnetic core 28 and is rotatable within the bore of stator 17. Eight essentially identical magnetic material elements or relatively thin arcuate segments 30 of permanent magnet material, each providing a relatively constant flux field, are secured, for example, by adhesive bonding to rotor core 28. The segments 30 are magnetized to be polarized radially in relation to the rotor core 28 with adjacent segments 30 being alternately polarized as indicated. While magnets 30 on rotor 12 are illustrated for purposes of disclosure, it is contemplated that other rotors having different constructions and other magnets different in both number, construction, and flux fields may be utilized with such other rotors so as to meet at least some of the objects thereof.

Stationary assembly 15 comprises a plurality of winding stages 32 adapted to be electrically energized to generate an electromagnetic field. Stages 32 are coils of wire wound around teeth 34 of the laminated stator core 17. The core 17 may be held together by four retainer clips 36, one positioned within each notch 38 in the outer surface of the core 17. Alternatively, the core 17 may be held together by other suitable means, such as for instance welding, interlocking, or adhesively bonding, or merely held together by the windings, all as will be understood by those skilled in the art. The winding end turns extend beyond the stator end faces and winding terminal leads 40 are brought out through an aperture 41 in the first end member 20 terminating in a connector 42. While stationary assembly 15 is illustrated for purposes of disclosure, it is contemplated that other stationary assemblies of various other constructions having different shapes and with different number of teeth may be utilized within the scope of the invention so as to meet at least some of the objects thereof.

Motor assembly 10 further includes a cap 44 which is mounted on the rear portion of the motor assembly 10 to enclose within the cap 44 control means 46 for the motor 13. The cap 44 includes an edge 48 having a plurality of spacing elements 50 projecting therefrom which engage the outer side 27 of the first end member 20. Cap 44 includes a substantially annular side wall 49 with the top of the side wall 49 forming edge 48. The control means 46 is positioned adjacent the outer side 27 of the first end member 20. The control means 46 includes a plurality of electronic components 52 and a connector (not shown) mounted on a component board 56, such as a printed circuit board. The control means 46 is connected to the winding stages 32 by interconnecting connector 42 and connector 54. The control means 46 applies a voltage to one or more of the winding stages 32 at a time for commutating the winding stages 32 in a preselected sequence to rotate the rotatable assembly 19 about an axis of rotation.

Connecting elements 58 comprising a plurality of bolts pass through bolt holes 60 in the second end member 22, bolt holes 61 in core 17, bolt holes 63 in first end member 20, and bolt holes 65 in cap 44. The head 67 of the connecting elements 58 engage the second end member 22. The connecting elements 58 are adapted to urge the second end member 22 and the cap 44 toward each other thereby supporting the first end member 20, the stationary assembly 15, and the rotatable assembly 19 therebetween. Additionally, a housing 62 may be positioned between the first end member 20 and the second end member 22 for enclosing and protecting the stationary assembly 15 and the rotatable assembly 10.

Electronically commutated motor 13 as described herein merely for purposes of disclosure is an eight rotor-pole motor, but it will be understood that the electronically commutated motor of this invention may include any even number of rotor poles and the number of stator poles are a multiple of the number of rotor poles, for example, the number of stator poles may be based on the number of phases. In one exemplary embodiment not shown in the Figures, a three-phase ECM includes six rotor pole pairs and 18 stator poles.

The motor assembly 10 according to the invention operates in the following manner. When the winding stages 32 are energized in a temporal sequence three sets of eight magnetic poles are established that will provide a radial magnetic field which moves clockwise or counterclockwise around the core 17 depending on the preselected sequence or order in which the stages are energized. This moving field intersects with the flux field of the magnet 30 poles to cause the rotor to rotate relative to the core 17 in the desired direction to develop a torque which is a direct function of the intensities or strengths of the magnetic fields.

The winding stages 32 are commutated without brushes by sensing the rotational position of the rotatable assembly 19 as it rotates within the core 17 and utilizing electrical signals generated as a function of the rotational position of the rotor 12 sequentially to apply a DC voltage to each of the winding stages 32 in different preselected orders or sequences that determine the direction of the rotation of the rotor 12. Position sensing may be accomplished by a position-detecting circuit responsive to the back electromotive force (EMF) to provide a simulated signal indicative of the rotational position of the rotor 12 to control the timed sequential application of voltage to the winding stages 32 of the motor 13. Other means of position sensing may also be used.

FIG. 2 illustrates the fully assembled motor assembly 10. Connecting elements 58 pass through the second end member 22, the stationary assembly 15, the first end member 20, and the cap 44. The connecting elements 58 have a portion 64 which projects laterally from the cap 44. Portion 64 is adapted to engage a support structure (not shown) for supporting the motor assembly 10. The connecting elements 58 may be secured in place by placing a nut 66 engaging the threads on each of the portions 64 of the connecting elements 58. A wiring harness 80 and connector 82 are utilized to connect motor assembly 10 to an electrical power source.

Spacing elements 50 when engageable with the outer side 27 of the first end member 20 form air gaps 68 between the spacing elements 50, the edge 48, and the outer side 27. The air gaps 68 permit flow through the cap 44 thereby dissipating heat generated by the motor assembly 10. Additionally, if the motor assembly 10 is exposed to rain the air gaps 68 permit rain which has entered the cap 44 to flow out of the cap 44 via the air gaps 68.

Indentations 75 are formed in a bottom 76 of the cap 44 which provide a space for a tool (not shown) to fit in to tighten the nuts 66. The indentations 75 also allow the nuts 66 to be mounted on the connecting elements 58 flush with the bottom 76 of the cap 44.

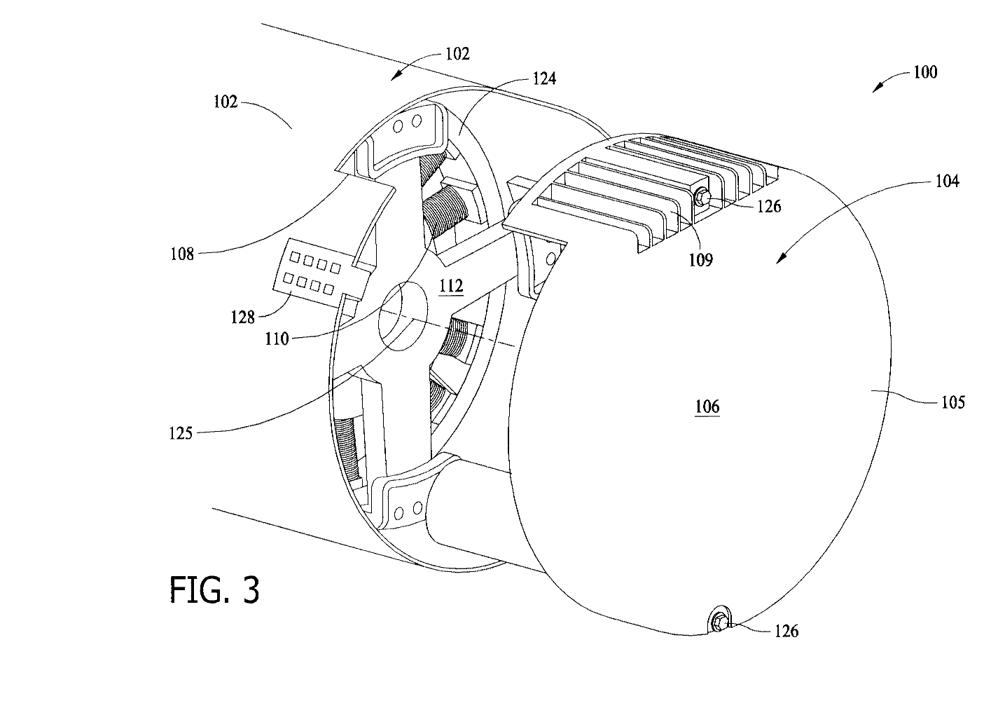

FIG. 3 is an exploded end view of an alternative embodiment for an ECM 100. Motor 100 includes a motor enclosure 102 and a motor control unit 104 configured for attachment to motor enclosure 102. A chassis 105 of motor control unit 104 serves as an end shield 106 for motor 100. Motor enclosure 102 also includes a slot 108 which engages a heat sink 109 formed in chassis 105 as further described below. While motor control unit 104 includes chassis 105, motor 100 is configured such that motor enclosure 102 provides substantially all of the enclosure for motor control unit 104. Within motor enclosure 102 are windings 110 of motor 100 and a mid shield 112 configured for placement between windings 110 and motor control unit 104.

The placement and configuration of mid shield 112 allows motor control unit 104 of motor 100 to be removed and replaced without disruption or displacement of a motor winding assembly 124 which includes windings 110 of motor 100. As illustrated, motor enclosure 102 is configured to form a part of the enclosure for motor control unit 104, along with end shield 106, allowing for a one-piece enclosure configuration. Mid shield 112 is also configured to meet any airflow, voltage clearances and assembly height limitations imposed on motor 100.

In one embodiment, as illustrated, mid shield 112 fits precisely with respect to a centerline 125 of motor 100 and further aligns with two bolts 126 that pass through end shield 106 of motor control unit 104 to clamp and secure mid shield 112 and motor control unit 104 within motor enclosure 102. This alignment and symmetry remain even when chassis 105 containing the electronics of motor control unit 104 is removed. Retaining the alignment and symmetry within enclosure 102 is important as it lowers a replacement cost of motor control unit 104 in the field. Mid shield 112 also contributes to a lower material cost for motor 100, because with mid shield 112, motor enclosure 102 is utilized as a part of the containment enclosure for portions of motor control unit 104 as shown in FIG. 3, decreasing the size of motor 100 as compared to motor 11 (shown in FIGS. 1 and 2). Additionally, such a configuration allows for a placement of a power connector 128 that is flush with chassis 102.

Utilization of mid shield 112 allows motor control unit 104 to be removed from enclosure 102 without disturbing the rest of the motor assembly, for example, windings 110. The non-disturbance is obtained by using mid shield 112 to secure a bearing that engages a motor shaft (neither shown in FIG. 1) of motor 100. Therefore, enclosure 102 is additionally configured to provide any required clearances for the electrical components (e.g., motor control unit 104) of motor 100 to allow disengagement of motor control unit 104 from motor 100.

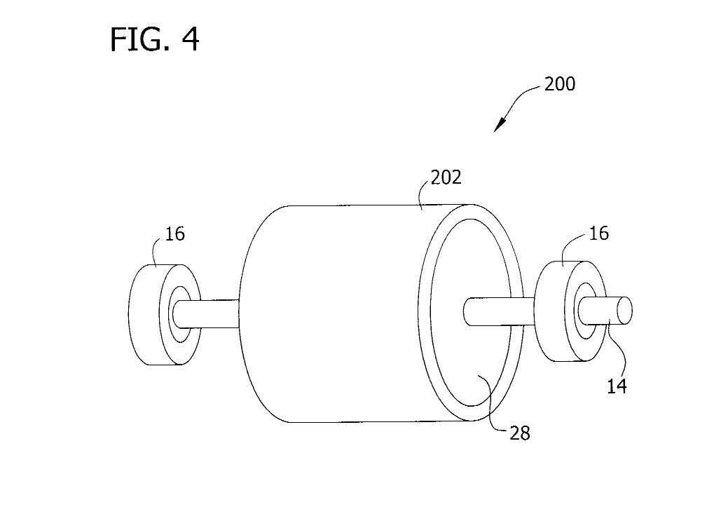

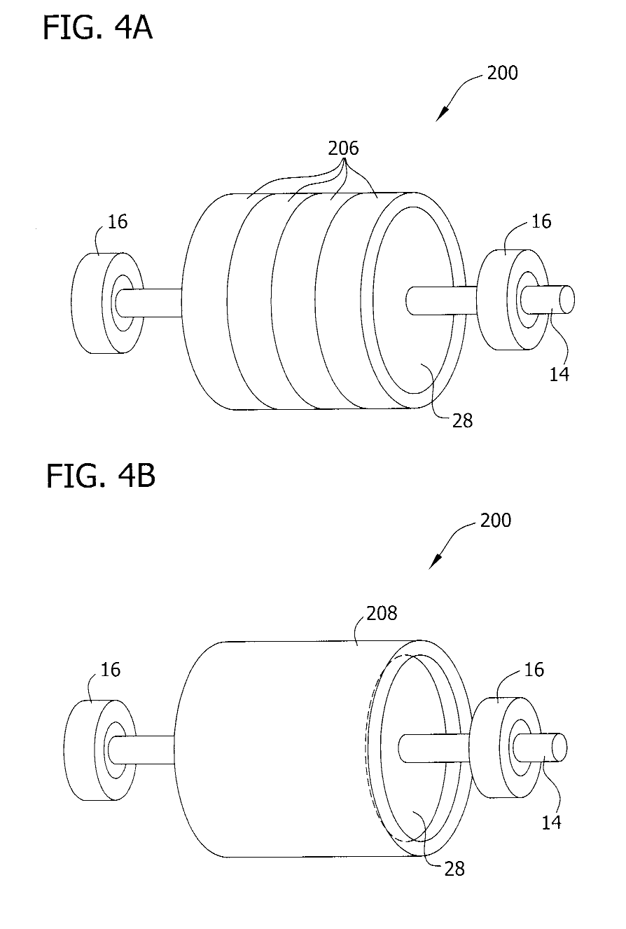

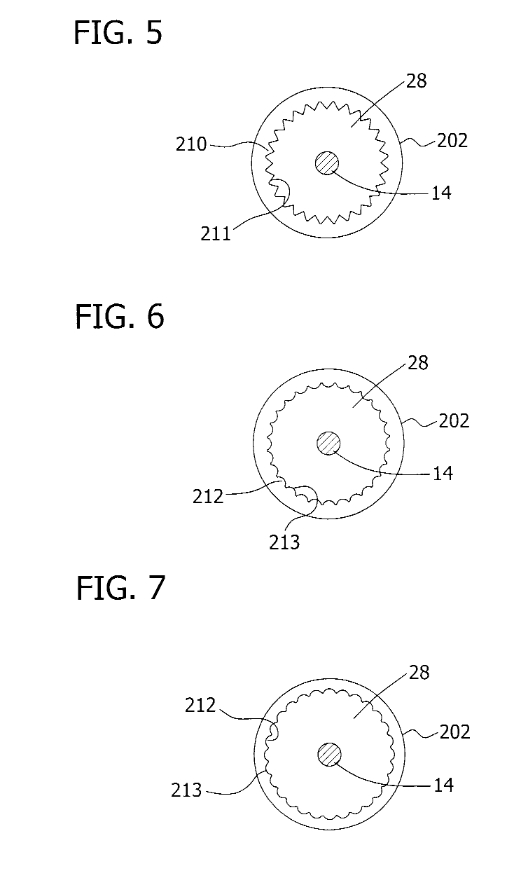

With regard to the embodiments described herein, FIG. 4 is a diagram of a rotor 200. Similar to rotor 12, described above with respect to FIG. 1, rotor 200 includes the same ferromagnetic core 28 and is rotatable within the bore of a stator. Rotor 200 is mounted on and keyed to the shaft 14 journaled for rotation in conventional bearings 16. Rather than the arcuate segments of permanent magnet material 30 (shown in FIG. 1), rotor 200 incorporates a ring shaped magnet 202 that is sized to engage the ferromagnetic core 28. In one embodiment, ring shaped magnet 202 is a neodymium magnet. While described herein as ring shaped, magnet 202 and other embodiments described herein may be referred to as being cylindrical in shape.

The neodymium embodiment of ring magnet 202 is a high energy bonded or sintered neodymium magnetic material. The ring shape of ring magnet 202 eliminates centrifugal force on the magnetic material because the ring magnet is in the ring form and has a sufficient hoop strength to overcome the shortcoming of the above described adhesive bonded magnetic arc segmented magnets.

In addition to the described application of the ring magnet 202 into the ECM (brushless DC motor) described herein, it is contemplated that various magnet ring embodiments are capable of use within the above described motors or other motor types.

Various embodiments of ring magnet 202 are also contemplated. For example, ring magnet 202 may incorporate more than one magnetic material or alternatively different magnetization levels of the same material to achieve different outputs in the same mechanical/hardware parts and stack of an electric motor. Other ring magnet embodiments include, a plurality of magnetic rings 206 in an end to end configuration as shown in FIG. 4A and FIG. 4B illustrates a configuration where the magnetic ring 208 overhangs the ferromagnetic core, which has an effect on an output power of the motor.

In addition, anti-rotation mechanisms are provided through the use of ring magnet 202. Examples, which are further described below, include a mechanism built into the ring magnet 202/rotor core 28 interface by mating geometries that include flat surfaces, V-notches, semicircular notches, regular rectangular notches, and inverted rectangular notches. In an alternative embodiment, the magnetic ring is pinned to the core 28 using an end plate and pins.

The described embodiments include the use of magnet material in the form of a ring rather than discrete magnet arcs which in part, operates to eliminate centrifugal force as a factor in the failure of adhesive bonds between the magnet material arcs and the rotor core. In embodiments where the magnetic ring is fabricated from high energy bonded neodymium or sintered neodymium, the resulting motor has an increased efficiency as well as a reduced physical size.

Some embodiments incorporate phantom slots in the stator teeth in conjunction with a skewed magnetized rotor field which results in reduced, or minimized, cogging torque as well as a reduction in noise and vibrations. In embodiments where the magnet ring overhangs the rotor core, a flux magnification results, as well as higher torque per ampere and increased motor efficiency. These features allow a manufacturer to use rotors and stators of the same length which simplifies manufacturing processes and avoids additional processing, equipment cost, and material costs that are currently utilized since rotors are longer than stators.

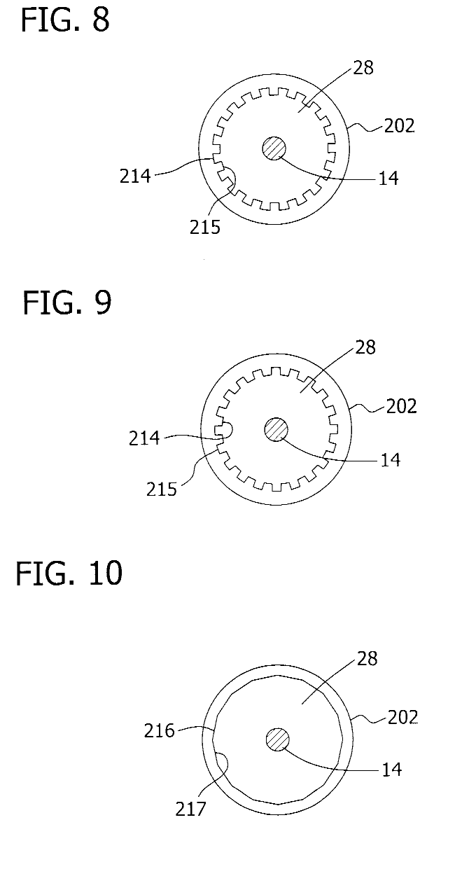

In addition, various mechanical configurations, for example geometric patterns, are incorporated into the rotors and magnetic ring described herein that are utilized to prevent relative motion and slipping of the magnet ring with respect to rotor core. FIGS. 5-10 illustrates several possible geometric configurations, though many others could be incorporated. These geometric patterns include triangular notches 210 in the inner diameter of the magnetic ring 202 and mating triangular notches 211 in the outer diameter of the ferromagnetic core 28 as shown in FIG. 5, various semicircular or other fractions of a circle patterns 212, 213 in the inner diameter of the magnetic ring 202 and corresponding mating semicircular or other parts of a circle patterns 213, 212 in the outer diameter of the ferromagnetic core 28 as shown in FIGS. 6 and 7, rectangular patterns 214, 215 in the inner diameter of the magnetic ring 202 and corresponding mating rectangular patterns 215, 214 in the outer diameter of the ferromagnetic core 28 as shown in FIGS. 8 and 9, and flattened surfaces 216 on the inner diameter of the magnet ring 202 and mating flattened surfaces 217 in the outer diameter of the ferromagnetic core 28 as shown in FIG. 10. Embodiments that include fewer or additional repetitions of the patterns shown in FIGS. 5-10 exist. Of course many other patterns and configurations are possible for inhibiting relative rotation between the inner diameter of the magnetic ring and the outer diameter of the rotor core.

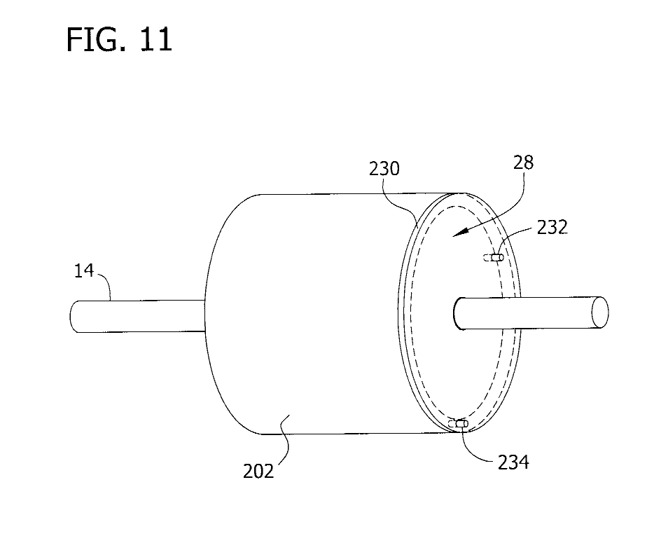

In an alternative embodiment, as illustrated in FIG. 11, rotor construction includes at least one end plate 230 having pins 232 and 234 therethrough. As illustrated, pin 232 extends through end plate 230 and into the ferromagnetic core 28 and pin 234 extends through end plate 230 and into the ring magnet 202. In other embodiments, two end plates 230 might be incorporated, one at each end of the rotor core / magnetic ring combination, with varying numbers of pins 232 and 234 in order to prevent relative motion between rotor core 28 and magnetic ring 202.

Other benefits that accrue from the use of neodymium in the ring magnet 202 include an embodiment (not shown) that incorporates an overhang of the magnet ring 202 with respect to the rotor core 28 which operates to increase output or torque per ampere and other related efficiency improvements. Finally, the use of phantom notches in the tooth face of the motor stator in combination with a skewed magnetic field within the neodymium ring magnet 202 reduces cogging torque and related noise and vibration in the end application.

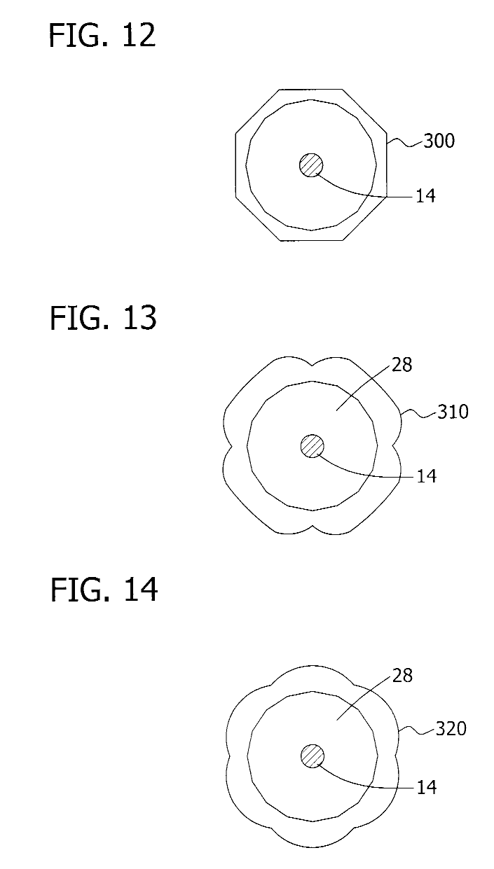

Other embodiments are contemplated which help reduce cogging torque, for example, and as illustrating in FIGS. 12-14, an outer diameter of the one or more magnetic rings can be shaped to reduce cogging torque. It is possible that, in the cases where multiple end to end magnetic rings are used, the different outer diameters can be differently shaped. Now referring specifically to FIG. 12, an outer diameter of magnetic ring 300 has an octagonal shape. In FIG. 13, an outer diameter of magnetic ring 310 has a “scalloped” shape. FIG. 14 illustrates a magnetic ring 320 having an alternative scalloping configuration. In one set of embodiments, the number of scallops or sides to a polygonal outer diameter is consistent with the number of poles of the motor. As an example, the embodiment of FIG. 13 indicates a four pole motor. All of the above described embodiments are understood to be examples only, and not limiting. For example, and referring to FIG. 12, any polygonal shape might be utilized for magnetic ring 300. With respect to FIG. 13 and 14, many alternative scalloping configurations are possible. It should also be noted that any pattern utilized for the inner diameter of the magnetic ring(s) and the outer diameter of the rotor core can be utilized with any magnetic ring outer diameter configuration.

One objective of the described embodiments is the elimination of the root cause of magnet material to rotor core bond failure. Specifically, the embodiments describe a magnetic ring material that reduces the centrifugal forces that result in bond failure. The use of neodymium in the magnetic ring provides high efficiency while still exhibiting a small physical size for the motor.

The electromagnetic configuration of a motor that incorporates the neodymium magnetic ring is configurable to minimize cogging torque. In some of these embodiments, the stator and the rotor core are the same length, therefore a low cost laminated structure can be utilized.

The subject matter of the present disclosure is described with specificity herein to meet statutory requirements. However, the description itself is not intended to limit the scope of this patent. Rather, it has been contemplated that the claimed subject matter might also be embodied in other ways, to include different steps or combinations of steps similar to the ones described in this document, in conjunction with other present or future technologies. Moreover, although the terms “step,” “block,” and/or “operation” may be used herein to connote different elements of methods employed, the terms should not be interpreted as implying any particular order among or between various steps herein disclosed unless and except when the order of individual steps is explicitly described.

This written description uses examples to disclose the described embodiments, including the best mode, and also to enable any person skilled in the art to practice the described embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rotor assembly for an electric motor, comprising:
a rotor shaft;
a ferromagnetic core mounted on said rotor shaft; and
at least one cylindrical shaped magnet configured to engage and substantially surround the length of said ferromagnetic core, said at least one magnet fabricated utilizing neodymium.

2. A rotor assembly according to claim 1 wherein said neodymium ring shaped magnet is fabricated utilizing at least one of a high energy bonding process and a sintering process.

3. A rotor assembly according to claim 1 wherein said at least one cylindrical shaped magnet is configured to have a hoop strength sufficient to overcome any centrifugal forces acting on said ferromagnetic core.

4. A rotor assembly according to claim 1 wherein said at least one cylindrical shaped magnet is magnetized with a skew, said at least one cylindrical shaped magnet operable in conjunction with a stator having phantom slots in the stator tooth face.

5. A rotor assembly according to claim 1 wherein said ring shaped magnet is configured to overhang said ferromagnetic core for flux magnification.

6. A rotor assembly according to claim 1 wherein:
said ring shaped magnet comprises a geometric pattern along the inner diameter thereof, and
said ferromagnetic core comprises a mating geometric pattern along an outer diameter thereof, said geometric pattern and said mating geometric pattern configured to inhibit relative rotation between said ring shaped magnet and said ferromagnetic core.

7. A rotor assembly according to claim 1 further comprising at least one end plate comprising a plurality of pins therethrough, at least one of said pins configured to engage said ring shaped magnet and at least one of said pins configured to engage said ferromagnetic core to prevent relative motion between said ferromagnetic core and said at least one ring shaped magnet.

8. A rotor assembly according to claim 1 wherein said at least one cylindrical shaped magnet comprises a plurality of cylindrical shaped magnets stacked axially along said ferromagnetic core.

9. A rotor assembly according to claim 1 wherein said at least one cylindrical shaped magnet comprises an outside diameter having at least one of a scalloped shape and a polygonal shape.

10. A rotor assembly according to claim 9 wherein the number of scallops in said scalloped shape and the number of sides to said polygonal shape correspond to a number of poles for a motor associated with said rotor assembly.

11. An electric motor comprising:
a rotor assembly comprising a rotor shaft, a ferromagnetic core mounted on said rotor shaft, and at least one ring shaped magnet configured to engage and substantially surround said ferromagnetic core, wherein said ring shaped magnets are fabricated from neodymium; and
a plurality of windings for causing a rotation of said rotor assembly.

12. An electric motor according to claim 11 wherein said at least one ring shaped magnet is fabricated utilizing at least one of a high energy bonding process and a sintering process.

13. An electric motor according to claim 11 wherein said at least one ring shaped magnet is configured to have a hoop strength sufficient to overcome any centrifugal forces acting on said ferromagnetic core.

14. An electric motor according to claim 11 wherein said at least one ring shaped magnet is magnetized with a skew and wherein said plurality of windings comprises a stator having phantom slots in a stator tooth face, the skew in the magnetization and the phantom slots defining a cogging torque associated with said motor.

15. An electric motor according to claim 11 wherein said at least one ring shaped magnet is configured to overhang said ferromagnetic core for flux magnification.

16. An electric motor according to claim 11 wherein:
said ring shaped magnet comprises a geometric pattern along the inner diameter thereof, and
said ferromagnetic core comprises a mating geometric along an outer diameter thereof, said geometric pattern and said mating geometric pattern configured to inhibit relative rotation between said ring shaped magnet and said ferromagnetic core.

17. An electric motor according to claim 11 further comprising at least one end plate comprising a plurality of pins therethrough, at least one of said pins configured to engage said ring shaped magnet and at least one of said pins configured to engage said ferromagnetic core to prevent relative motion between said ferromagnetic core and said ring shaped magnet.

18. An electric motor according to claim 11 wherein said at least one ring shaped magnet comprises a plurality of cylindrical shaped magnets stacked axially along said ferromagnetic core.

19. An electric motor according to claim 11 wherein said at least one cylindrical shaped magnet comprises an outside diameter having at least one of a scalloped shape and a polygonal shape.

20. An electric motor according to claim 19 wherein the number of scallops in said scalloped shape and the number of sides to said polygonal shape correspond to a number of poles for said electric motor.

21. An electric motor comprising:
a stator assembly; and
a rotor assembly comprising a rotor shaft, a ferromagnetic core mounted on said rotor shaft, and at least one ring shaped magnet configured to engage and substantially surround said ferromagnetic core, an output of said motor configurable based on at least one of a magnetic material utilized in the fabrication of said at least one ring shaped magnet and a magnetization level of said at least one ring shaped magnet.

22. An electric motor according to claim 21 wherein said at least one ring shaped magnet is fabricated from neodymium.

23. An electric motor according to claim 21 wherein an output of said motor is configurable based on at least one of:
a lack of overhang of said at least one ring shaped magnet over said ferromagnetic core; and
an amount of overhang of said at least one ring shaped magnet over said ferromagnetic core.
